(19) United States
(12) Patent Application Publication
(10) Pub. No.: US 2024/0136561 A1
(43) Pub. Date: Apr. 25, 2024

(54) ELECTRICAL REGENERATION OF ELECTROLYTES

(71) Applicant: President and Fellows of Harvard College, Cambridge, MA (US)

(72) Inventors: Marc-Antoni GOULET, Cambridge, MA (US); Min WU, Cambridge, MA (US); Yan JING, Cambridge, MA (US); Eric FELL, Cambridge, MA (US); Daniel POLLACK, Cambridge, MA (US); Shijian JIN, Cambridge, MA (US); Michael J. AZIZ, Cambridge, MA (US); Roy G. GORDON, Cambridge, MA (US)

(21) Appl. No.: 18/276,957

(22) PCT Filed: Feb. 11, 2022
(86) PCT No.: PCT/US2022/016193

§ 371 Date: Aug. 11, 2023

Related U.S. Application Data
(60) Provisional application No. 63/148,919, filed on Feb. 12, 2021.

(51) Int. Cl. H01M 8/18

(52) U.S. Cl. CPC H01M 8/188; H01M 2300/0014

(57) ABSTRACT

The invention provides flow batteries and methods of using flow batteries that reduce loss of capacity. The loss of capacity may be mitigated by electrically oxidizing an organic species in the negolyte.

### STATEMENT REGARDING FEDERALLY SPONSORED RESEARCH

This invention was made with government support under DE-AC36-08GO28308 and DE-AR0000767, awarded by the Department of Energy, and under CBET-1509041, and CBET-1914543 awarded by, awarded by the National Science Foundation. The government has certain rights in the invention.

### BACKGROUND OF THE INVENTION

The cost of electricity generated from renewable sources such as the sun and wind has become competitive with electricity derived from fossil fuels. Nonetheless, the widespread adoption of intermittent renewable electricity requires new methods for the reliable storage and delivery of electricity over long periods when these sources are unavailable for generation. Redox flow batteries (RFBs), whose energy and power capabilities can be scaled independently, may enable cost-effective long-duration discharge.

The all-vanadium redox flow battery chemistry is currently the most technologically developed but may not access much of the grid storage market due to electrolyte cost constraints. Emerging organic electrolytes comprising cheaper earth-abundant elements may address this limitation. However, organic electrolytes are more prone to molecular decomposition, which can lead to a progressive loss of charge storage capacity. Accordingly, there is a need for mechanisms to reverse decomposition.

### SUMMARY OF THE INVENTION

The invention features methods to extend the life of redox flow batteries by electrochemically regenerating negolytes. The invention features methods to extend the life of redox flow batteries by electrochemically regenerating negolytes as well as rebalancing the oxidized and reduced states of redox species in both negolytes and posolytes.

In an aspect, the invention provides a method of discharging a flow battery including the steps of a) providing a flow battery including a negolyte including an organic species in aqueous solution or suspension in contact with a first electrode, a posolyte including a redox active species in contact with a second electrode, and a barrier separating the negolyte and posolyte, where the organic species degrades to a degradation product when the flow battery is discharged; b) discharging the flow battery so that that the negolyte is oxidized and the posolyte is reduced; and c) applying an electrical pulse to the negolyte sufficient to revert the degradation product to oxidized organic species. In embodiments of the methods described herein, the organic species is a hydroquinone.

In embodiments of the methods described herein, the hydroquinone is a reduced form of an anthraquinone, e.g., of formula (I):

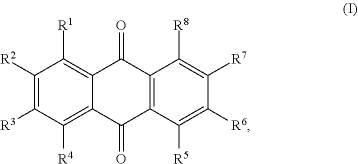

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —SRₐ; —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R₁, R₂, R₃, and R₄ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. An exemplary anthraquinone is 2,6-dihydroxy-9,10-anthraquinone. An exemplary degradation product of a quinone is an anthrone. In certain embodiments, the organic species is a naphthoquinone, a reduced phenazine, a reduced fluorenone, a reduced N,N′-disubstituted phenazine, a reduced monoquaternized or N,N′-diquaternized phenazine, a reduced phenoxazine, a reduced phenothiazine, or a reduced diquaternized bipyridine.

In embodiments of the methods described herein, the electrical pulse is applied for between about 0.1 to about 48 hours. In some embodiments, the electrical pulse applied is at a potential above the oxidation potential of the degradation product. In some embodiments, the electrical pulse is at a potential least +100 mV above the oxidation potential of the degradation product, e.g., about +100 mV to about +1500 mV (e.g., about +500 mV) above the oxidation potential of the degradation product.

In embodiments of the methods described herein, step (c) further includes providing at least one electrocatalyst to the negolyte. In some embodiments, the electrocatalyst includes graphene, carbon nanotubes, carbon nanoparticles, metal nanoparticles, or metal oxide nanoparticles.

In embodiments of the methods described herein, step (c) further includes providing one or more redox mediators to the negolyte. In some embodiments, the one or more redox mediators includes molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl-butanoic acid)), DBAQ (4,4′-(9,10-anthraquinone-diyl)dibutanoic acid), DPAQ (anthraquinone-2,6-dipropionic acid), a benzoquinone, or a naphthoquinone.

In embodiments of the methods described herein, step (c) further includes altering the pH of the negolyte. In some embodiments, the electrode used to apply the electrical pulse includes carbon or a metal. In some embodiments, the electrode used to apply the electrical pulse includes stainless steel, titanium, copper, bismuth, or lead.

In embodiments of the methods described herein, the redox active species includes bromine, chlorine, iodine, molecular oxygen, vanadium, chromium, cobalt, iron, aluminum, manganese, cobalt, nickel, copper, or lead.

In embodiments of the methods described herein, the battery is cycled for at least 100 times.

In an aspect, the invention provides a flow battery including i) a negolyte including an organic species in aqueous solution or suspension in contact with a first electrode; ii) a posolyte including a redox active species in contact with a second electrode; iii) a barrier separating the negolyte and posolyte; and iv) a third electrode in contact with the negolyte, where the third electrode is disposed to apply an electrical pulse to the negolyte.

In embodiments of the batteries described herein, batteries may include a fourth electrode in contact with the negolyte. In certain embodiments, the third and/or fourth electrode is disposed within a reservoir holding the negolyte. In some embodiments, the third and fourth electrodes are disposed in an electrochemical cell into which the negolyte is placed, e.g., pumped from a storage reservoir.

In embodiments of the batteries described herein, the organic species is a hydroquinone. In some embodiments, the hydroquinone is a reduced form of an anthraquinone, e.g., of formula (I):

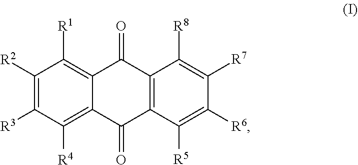

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —SRₐ; —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. An exemplary anthraquinone is 2,6-dihydroxy-9,10-anthraquinone.

In some embodiments, the organic species is a naphthoquinone, a reduced phenazine, a reduced N,N′-disubstituted phenazine, a reduced monoquaternized or N,N′-diquaternized phenazine, a reduced phenoxazine, a reduced phenothiazine, a reduced fluorenone, or a reduced diquaternized bipyridine.

In certain embodiments of the batteries described herein, the first and third and/or third and fourth electrodes are disposed to provide the electrical pulse at a potential above the oxidation potential of the degradation product. In some embodiments, the first and third and/or third and fourth electrodes are disposed to provide the electrical pulse at a potential least +100 mV above the oxidation potential of the degradation product, e.g., about +100 mV to about +1500 mV (e.g., about +500 mV) above the oxidation potential of the degradation product.

In some embodiments, the batteries described herein may include at least one electrocatalyst in contact with the negolyte. In some embodiments, the electrocatalyst includes graphene, carbon nanotubes, carbon nanoparticles, metal nanoparticles, or metal oxide nanoparticles.

In certain embodiments, the batteries described herein may include one or more redox mediators in contact with the negolyte. In some embodiments, the one or more redox mediators includes molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl-butanoic acid)), DBAQ (4,4′-(9,10-anthraquinone-diyl)dibutanoic acid), DPAQ (anthraquinone-2,6-dipropionic acid), a benzoquinone, or a naphthoquinone. In some embodiments, the batteries described herein include a source of hydronium and/or hydroxide ions.

In certain embodiments of the batteries described herein, one or more of the first, second, third, and fourth electrodes includes carbon or a metal. In some embodiments, one or more of the first, third, and fourth electrodes includes stainless steel, titanium, copper, bismuth, or lead.

In embodiments of the batteries described herein, the redox active species includes bromine, chlorine, iodine, molecular oxygen, vanadium, chromium, cobalt, iron, aluminum, manganese, cobalt, nickel, copper, or lead.

By “about” is meant ±10% of a recited value.

By “alkoxy” is meant a group of formula —OR, where R is an alkyl group, as defined herein.

By “alkyl” is meant straight chain or branched saturated groups from 1 to 6 carbons. Alkyl groups are exemplified by methyl, ethyl, n- and iso-propyl, n-, sec-, iso- and tert-butyl, neopentyl, and the like, and may be optionally substituted with one or more, substituents.

By “alkylene” is meant a divalent alkyl group.

By “alkyl thio” is meant —SR, where R is an alkyl group, as defined herein.

By “alkyl ester” is meant —COOR, where R is an alkyl group, as defined herein.

By “aryl” is meant an aromatic cyclic group in which the ring atoms are all carbon. Exemplary aryl groups include phenyl, naphthyl, and anthracenyl. Aryl groups may be optionally substituted with one or more substituents.

By “carbocyclyl” is meant a non-aromatic cyclic group in which the ring atoms are all carbon. Exemplary carbocyclyl groups include cyclopropyl, cyclobutyl, cyclopentyl, cyclohexyl, cycloheptyl, and cyclooctyl. Carbocyclyl groups may be optionally substituted with one or more substituents.

By “halo” is meant, fluoro, chloro, bromo, or iodo.

By “hydroxyl” is meant —OH. An exemplary ion of hydroxyl is —O⁻.

By “amino” is meant —NH₂. An exemplary ion of amino is —NH₃⁺.

By “nitro” is meant —NO₂.

By “carboxyl” is meant —COON. An exemplary ion of carboxyl is —COO⁻.

By “phosphoryl” is meant —PO₃H₂. Exemplary ions of phosphoryl are —PO₃H⁻ and —PO₃²⁻.

By “phosphonyl” is meant —PO₃R₂, where each R is H or alkyl, provided at least one R is alkyl, as defined herein. An exemplary ion of phosphoryl is —PO₃R⁻.

By “oxo” is meant ═O.

By “sulfonyl” is meant —SO₃H. An exemplary ion of sulfonyl is —SO₃⁻.

By “thiol” is meant —SH.

By “heteroaryl” is meant an aromatic cyclic group in which the ring atoms include at least one carbon and at least one O, N, or S atom, provided that at least three ring atoms are present. Exemplary heteroaryl groups include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl. Heteroaryl groups may be optionally substituted with one or more substituents.

By “heteroalkylene” is meant an alkylene group in which one or more CH₂ units are replaced with one or more heteroatoms selected from O, N, and S. Heteroalkylene can be substituted by oxo (═O). An exemplary heteroalkylene includes an amido group, e.g., —(CH₂)ₙC(O)NH(CH₂)ₘ—, wherein n and m are independently 1-6.

By “heterocyclyl” is meant a non-aromatic cyclic group in which the ring atoms include at least one carbon and at least one O, N, or S atom, provided that at least three ring atoms are present. Exemplary heterocyclyl groups include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents.

By “hydrocarbyl” is meant a branched, unbranched, cyclic, or acyclic group including the elements C and H. Hydrocarbyl groups may be monovalent, e.g., alkyl, or divalent, e.g., alkylene. Hydrocarbyl groups may be substituted with groups including oxo (═O).

By an “oxygen protecting group” is meant those groups intended to protect an oxygen containing (e.g., phenol, hydroxyl, or carbonyl) group against undesirable reactions during synthetic procedures. Commonly used oxygen protecting groups are disclosed in Greene, “Protective Groups in Organic Synthesis,” 3rd Edition (John Wiley & Sons, New York, 1999), which is incorporated herein by reference. Exemplary oxygen protecting groups include acyl, aryloyl, or carbamyl groups, such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, α-chlorobutyryl, benzoyl, 4-chlorobenzoyl, 4-bromobenzoyl, t-butyldimethylsilyl, tri-iso-propylsilyloxymethyl, 4,4′-dimethoxytrityl, isobutyryl, phenoxyacetyl, 4-isopropylpehenoxyacetyl, dimethylformamidino, and 4-nitrobenzoyl; alkylcarbonyl groups, such as acyl, acetyl, propionyl, and pivaloyl; optionally substituted arylcarbonyl groups, such as benzoyl; silyl groups, such as trimethylsilyl (TMS), tert-butyldimethylsilyl (TBDMS), tri-iso-propylsilyloxymethyl (TOM), and triisopropylsilyl (TIPS); ether-forming groups with the hydroxyl, such methyl, methoxymethyl, tetrahydropyranyl, benzyl, p-methoxybenzyl, and trityl; alkoxycarbonyls, such as methoxycarbonyl, ethoxycarbonyl, isopropoxycarbonyl, n-isopropoxycarbonyl, n-butyloxycarbonyl, isobutyloxycarbonyl, sec-butyloxycarbonyl, t-butyloxycarbonyl, 2-ethylhexyloxycarbonyl, cyclohexyloxycarbonyl, and methyloxycarbonyl; alkoxyalkoxycarbonyl group, such as methoxymethoxycarbonyl, ethoxymethoxycarbonyl, 2-methoxyethoxycarbonyl, 2-ethoxyethoxycarbonyl, 2-butoxyethoxycarbonyl, 2-methoxyethoxymethoxycarbonyl, allyloxycarbonyl, propargyloxycarbonyl, 2-butenoxycarbonyl, and 3-methyl-2-butenoxycarbonyl; haloalkoxycarbonyls, such as 2-chloroethoxycarbonyl, 2-chloroethoxycarbonyl, and 2,2,2-trichloroethoxycarbonyl; optionally substituted arylalkoxycarbonyl groups, such as benzyloxycarbonyl, p-methylbenzyloxycarbonyl, p-methoxybenzyloxycarbonyl, p-nitrobenzyloxycarbonyl, 2,4-dinitrobenzyloxycarbonyl, 3,5-dimethylbenzyloxycarbonyl, p-chlorobenzyloxycarbonyl, p-bromobenzyloxy-carbonyl, and fluorenylmethyloxycarbonyl; and optionally substituted aryloxycarbonyl groups, such as phenoxycarbonyl, p-nitrophenoxycarbonyl, o-nitrophenoxycarbonyl, 2,4-dinitrophenoxycarbonyl, p-methyl-phenoxycarbonyl, m-methylphenoxycarbonyl, o-bromophenoxycarbonyl, 3,5-dimethylphenoxycarbonyl, p-chlorophenoxycarbonyl, and 2-chloro-4-nitrophenoxy-carbonyl); substituted alkyl, aryl, and alkaryl ethers (e.g., trityl; methylthiomethyl; methoxymethyl; benzyloxymethyl; siloxymethyl; 2,2,2,-trichloroethoxymethyl; tetrahydropyranyl; tetrahydrofuranyl; ethoxyethyl; 1-[2-(trimethylsilyl)ethoxy]ethyl; 2-trimethylsilylethyl; t-butyl ether; p-chlorophenyl, p-methoxyphenyl, p-nitrophenyl, benzyl, p-methoxybenzyl, and nitrobenzyl); silyl ethers (e.g., trimethylsilyl; triethylsilyl; triisopropylsilyl; dimethylisopropylsilyl; t-butyldimethylsilyl; t-butyldiphenylsilyl; tribenzylsilyl; triphenylsilyl; and diphenymethylsilyl); carbonates (e.g., methyl, methoxymethyl, 9-fluorenylmethyl; ethyl; 2,2,2-trichloroethyl; 2-(trimethylsilyl)ethyl; vinyl, allyl, nitrophenyl; benzyl; methoxybenzyl; 3,4-dimethoxybenzyl; and nitrobenzyl); carbonyl-protecting groups (e.g., acetal and ketal groups, such as dimethyl acetal, and 1,3-dioxolane; acylal groups; and dithiane groups, such as 1,3-dithianes, and 1,3-dithiolane); carboxylic acid-protecting groups (e.g., ester groups, such as methyl ester, benzyl ester, t-butyl ester, and orthoesters; and oxazoline groups.

By a “nitrogen protecting group” is meant those groups intended to protect an amino group against undesirable reactions during synthetic procedures. Commonly used nitrogen protecting groups are disclosed in Greene, “Protective Groups in Organic Synthesis,” 3rd Edition (John Wiley & Sons, New York, 1999), which is incorporated herein by reference. Nitrogen protecting groups include acyl, aryloyl, or carbamyl groups such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, α-chlorobutyryl, benzoyl, 4-chlorobenzoyl, 4-bromobenzoyl, 4-nitrobenzoyl, and amino acids such as alanine, leucine, and phenylalanine; sulfonyl-containing groups such as benzenesulfonyl, and p-toluenesulfonyl; carbamate forming groups such as benzyloxycarbonyl, p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxpenzyloxycarbonyl, 1-(p-biphenylyl)-1-methylethoxycarbonyl, α,α-dimethyl-3,5-dimethoxybenzyloxycarbonyl, benzhydryloxy carbonyl, t-butyloxycarbonyl, diisopropylmethoxycarbonyl, isopropyloxycarbonyl, ethoxycarbonyl, methoxycarbonyl, allyloxycarbonyl, 2,2,2,-trichloroethoxycarbonyl, phenoxycarbonyl, 4-nitrophenoxy carbonyl, fluorenyl-9-methoxycarbonyl, cyclopentyloxycarbonyl, adamantyloxycarbonyl, cyclohexyloxycarbonyl, and phenylthiocarbonyl, alkaryl groups such as benzyl, triphenylmethyl, and benzyloxymethyl, and silyl groups, such as trimethylsilyl. Preferred nitrogen protecting groups are alloc, formyl, acetyl, benzoyl, pivaloyl, t-butylacetyl, alanyl, phenylsulfonyl, benzyl, t-butyloxycarbonyl (Boc), and benzyloxycarbonyl (Cbz).

For the purposes of this invention, the term “quinone” includes a compound having one or more conjugated, C₃₋₁₀ carbocyclic, fused rings, substituted, in oxidized form, with two or more oxo groups, which are in conjugation with the one or more conjugated rings. Preferably, the number of rings is from one to ten, e.g., one, two, or three, and each ring has 6 members.

As noted, substituents may be optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Cyclic substituents may also be substituted with C₁₋₆ alkyl. In specific embodiments, substituents may include optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —NO₂; —ORₐ; —N(Rₐ)₂; —C(═O)Rₐ; —C(═O)ORₐ; —S(═O)₂Rₐ; —S(═O)₂ORₐ; —P(═O)Rₐ₂; —O—P(═O)(ORₐ)₂, or —P(═O)(ORₐ)₂, or an ion thereof; where each Rₐ is independently H, optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group, and cyclic substituents may also be substituted with C₁₋₆ alkyl. In specific embodiments, alkyl groups may be optionally substituted with one, two, three, or, in the case of alkyl groups of two carbons or more, four substituents independently selected from the group consisting of halo, hydroxyl, C₁₋₆ alkoxy, SO₃H, amino, nitro, carboxyl, phosphoryl, phosphonyl, thiol, C₁₋₆ alkyl ester, optionally substituted C₁₋₆ alkyl thio, and oxo, or an ion thereof.

Exemplary ions of substituent groups are as follows: an exemplary ion of hydroxyl is —O⁻; an exemplary ion of —COON is —COO⁻; exemplary ions of —PO₃H₂ are —PO₃H⁻ and —PO₃²⁻; an exemplary ion of —PO₃HRₐ is —PO₃Rₐ⁻, where Rₐ is not H; exemplary ions of —PO₄H₂ are —PO₄H⁻ and —PO₄²⁻; and an exemplary ion of —SO₃H is —SO₃⁻.

### BRIEF DESCRIPTION OF THE DRAWINGS

FIG. 1 Shows cyclic voltammograms of DHA before and after applying a +200 mV electrical pulse for 20 min.

FIG. 2 Shows full cell cycling of 0.5 M DHAQ vs 0.4 M ferrocyanide cell, where DHAQ negolyte contains 50 mM of ferrocyanide to act as oxidative mediator.

FIG. 3 Shows full cell cycling after 100 cycles, before and after an electrical pulse at 0.05 V for ˜40 min. Cut-off conditions are 0.0 V →1 mA (0.2 mA/cm²). Full description of parameters and conditions is shown in Table 1.

FIG. 4 Shows full cell cycling for 100 cycles followed by an electrical pulse at various potentials. Cut-off conditions are 0.0 V →1 mA (0.2 mA/cm²). Full description of parameters and conditions is shown in Table 1.

FIG. 5 is a table showing capacity recovery after an electrical pulse at various potentials in three cells (ch01, ch02, and ch03) cycled 100 times prior to the electrical pulse. Cut-off conditions are 0.0 V →1 mA (0.2 mA/cm²). Full description of parameters and conditions is shown in Table 1.

### DETAILED DESCRIPTION OF THE INVENTION

Redox flow batteries have emerged as promising systems for energy storage from intermittent renewable sources. The lifetime of these batteries is limited by electrolyte stability. Under ideal conditions, discharging a flow battery involves the reversible oxidation and concurrent reduction of the low potential (negolyte) and high potential (posolyte) active species, respectively. However, many negolytes and posolytes are subject to various degradation mechanisms, which lead to capacity loss.

One system that demonstrates such capacity loss is a RFB utilizing the inexpensive redox couples of 2,6-dihydroxyanthraquinone (DHAQ) and potassium salts of iron hexacyanide (Fe(CN)₆), where irreversible dimerization is the mechanism of capacity loss, as described in WO 2020/072406. In a DHAQ/Fe(CN)₆ flow battery, the reactions and potentials vs SHE are

| | |
|---|---|
| Negolyte: DHAQ²⁻ + 2e⁻ [symbol] DHAHQ⁴⁻ | −680 mV; (pH 14) |
| Posolyte: [Fe(CN)₆]³⁻ + e⁻ [symbol] [Fe(CN)₆]⁴⁻ | +510 mV |

In practice, decomposition of the negolyte active species causes the battery capacity to fade at ˜5-8%/day. As this rate limits the lifetime to the order of 1 week, identifying and inhibiting the mechanism of capacity loss is critical for the battery to approach the decadal service life that will be necessary for large-scale grid storage applications. Herein, we demonstrate that capacity loss can be suppressed through application of an electrical pulse.

### Flow Batteries

Flow batteries of the invention include a negolyte that includes, e.g., an organic species, e.g., an anthrahydroquinone dissolved or suspended in aqueous solution; a posolyte that includes, e.g., a redox active species; and a barrier separating the two. The battery further includes at least two electrodes, one in contract with the negolyte and one in contact with the posolyte. Flow batteries of the invention may include a third and/or fourth electrode in contact with the negolyte. In certain embodiments, the third and/or fourth electrode(s) is/are disposed within a reservoir.

In some embodiments, the negolyte includes an organic species that is a hydroquinone. The hydroquinone may be a reduced form of an anthraquinone, e.g., of formula (I):

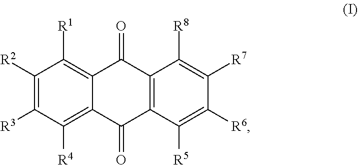

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. An anthraquinone of the invention is a source of electrons during discharge and not merely a charge transfer agent. In embodiments, the anthraquinone is water soluble.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, R⁴, R⁵, R⁶, R⁷, and R⁸ is independently selected from H, hydroxyl, optionally substituted C₁₋₄ alkyl, carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H.

In other embodiments, the anthraquinone, such as a 9,10-anthraquinone, is substituted with at least one hydroxyl group and optionally further substituted with a C₁₋₄ alkyl, such as methyl. Exemplary quinones include 2,6-dihydroxy-9,10-anthraquinone (2,6-DHAQ), 1,5-dimethyl-2,6-dihydroxy-9,10-anthraquinone, 2,3,6,7-tetrahydroxy-9,10-anthraquinone, 1,3,5,7-tetrahydroxy-2,4,6,8-tetramethyl-9,10-anthraquinone, and 2,7-dihydroxy-1,8-dimethyl-9,10-anthraquinone. Ions and reduced species thereof are also contemplated.

Other organic species amenable to use in batteries of the invention include, but are not limited to, naphthoquinones (e.g., hydronaphthoquinones), reduced forms of phenazines (e.g., the reduced form of 7,8-dihydroxyphenazine-2-sulfonic acid), reduced monoquaternized or N,N′-diquaternized phenazines, reduced phenoxazines, reduced phenothiazines, reduced fluorenones, or reduced forms of diquaternized bipyridines (e.g., alkyl viologen radical monocations).

Exemplary reduced phenazines, a N,N′-disubstituted phenazines, monoquaternized phenazines, or N,N′-diquaternized phenazines are, e.g., reduced forms (e.g., 5,10-dihydrophenazines) of formula (II):

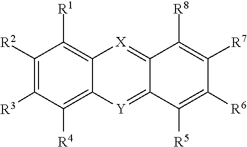

or a salt thereof,

where X and Y are both N, or where X is NR_{X} and Y is N, or where X is NR^{X} and Y is NR^{Y};

where R^{X} and R^{Y} are independently selected from H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group;

where each of R₁, R₂, R₃, R₄, R₅, R₆, R₇ and R₈ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, R⁴, R⁵, R⁶, R⁷, and R⁸ is independently selected from H, hydroxyl, optionally substituted C₁₋₄ alkyl, carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H. In some embodiments, at least one of R₁-R₈ is a substituted alky or substituted alkoxy.

Exemplary phenazines include, e.g., 7,8-dihydroxyphenazine-2-sulfonic acid. Ions and reduced species thereof are also contemplated.

Exemplary reduced phenoxazines and phenothiazines are reduced forms of, e.g., formula (III):

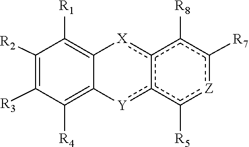

or a salt thereof,

where dashed bonds are single or double bonds; where X is N or NR^{X}, Y is O or S, and Z is CR⁶, C═O, C═S, C═NR^{Z}, or C═NH⁺R^{Z};

where R^{X} is selected from H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group,

where R^{Z} is selected from H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; or a nitrogen protecting group

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, R⁴, R⁵, R⁶, R⁷, and R⁸ is independently selected from H, hydroxyl, optionally substituted C₁₋₄ alkyl, carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H. In some embodiments, at least one of R¹-R⁸ is a substituted alky or substituted alkoxy.

Exemplary reduced diquaternized bipyridines are reduced forms (e.g., singly reduced radical monocations or doubly reduced 4,4′-bipyridinylidenes) of, e.g., formula (IV):

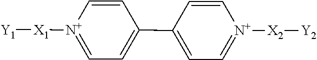

or a salt thereof,

where X₁ and X₂ are independently optionally substituted C₁₋₂₀ hydrocarbyl (e.g., C₁₋₁₀ alkylene) or heteroalkylene, and Y₁ and Y₂ are independently an optionally substituted water solubilizing group, e.g., a quaternary ammonium (e.g., trimethyl ammonium), ammonium, nitrogen-containing heterocyclyl, sulfonate, or sulfate. In certain embodiments, X₁ and X₂ are independently C₁₋₁₀ alkylene, e.g., C₃₋₆ alkylene. Exemplary groups for Y₁ and Y₂ are quaternary ammonium independently substituted with three C₁₋₆ hydrocarbyl groups, e.g., trimethyl ammonium. An exemplary diquaternized bipyridine is

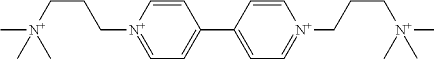

or a salt thereof.

In particular embodiments, the water-solubilizing group is charged at a pH between 6-8. Further embodiments of diquaternized bipyridines may have the above formula, except that the two pyridines are linked 2-2′ instead of 4-4′. Ions and reduced species thereof are also contemplated.

In some embodiments, the negolyte includes an organic species that is a naphthohydroquinone. The naphthohydroquinone may be a reduced for of a naphthoquinone, e.g., of formula (V):

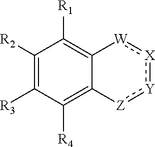

or a salt thereof,

wherein the dashed bonds are single or double bonds; where either W and X, W and Z, or Z and Y are C═O, and where the two of W, X, Y, or Z that are not C═O are independently selected from C—R, where R is H; halo; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent R groups are joined to form an optionally substituted non-aromatic 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group; where each of R¹, R², R³, and R⁴ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. In certain embodiments, W and Z are C═O.

In certain embodiments, each of R¹, R², R³, and R⁴ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, and R⁴ is independently selected from H, hydroxyl, optionally substituted C₁₋₄ alkyl, carboxyl, and SO₃H, such as each of R¹, R², R³, and R⁴ being independently selected from H, hydroxyl, optionally substituted C₁₋₄ alkyl (e.g., methyl), and oxo. In embodiments, at least one, e.g., at least two, of R¹, R², R³, and R⁴ is not H. In some embodiments, at least one of R¹-R⁴ is a substituted alky or substituted alkoxy. Ions and reduced species thereof are also contemplated.

Exemplary reduced fluorenones are reduced forms of formula (VI):

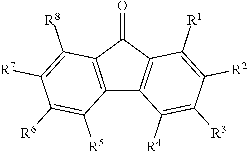

where each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ (e.g., hydroxyl or C₁₋₆ alkoxy); —SRₐ (e.g., thiol or C₁₋₆ alkyl thio); —N(Rₐ)₂ (e.g., amino); —C(═O)Rₐ; —C(═O)ORₐ (e.g., carboxyl); —S(═O)₂Rₐ; —S(═O)₂ORₐ (e.g., SO₃H); —P(═O)Rₐ₂; and —P(═O)(ORₐ)₂ (e.g., phosphonyl or phosphoryl); or any two adjacent groups selected from R¹, R², R³, and R⁴ are joined to form an optionally substituted 3-6 membered ring, or an ion thereof, where each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. In embodiments, the fluorenone is water soluble.

In certain embodiments, each of R¹, R², R³, R⁴, R⁵, R⁶, R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R¹, R², R³, R⁴, R⁵, R⁶, R⁷, and R⁸ is independently selected from H, hydroxyl, optionally substituted C₁₋₄ alkyl, carboxyl, and SO₃H, such as each of R¹, R², R³, R⁴, R⁵, R⁶, R⁷ and R⁸ being independently selected from H, hydroxyl, optionally substituted C₁₋₄ alkyl (e.g., methyl), and oxo. In embodiments, at least one, e.g., at least two, of R¹, R², R³, R⁴, R⁵, R⁶, R⁷, and R⁸ is not H.

Organic species, e.g., hydroquinones, may be present in a mixture. An organic species of the invention is a source of electrons during discharge and not merely a charge transfer agent. In embodiments, the organic species is water soluble.

Examples of redox active species for the posolyte include bromine, chlorine, iodine, molecular oxygen, vanadium, chromium, cobalt, iron (e.g., ferricyanide/ferrocyanide or a ferrocene derivative, e.g., as described in WO 2018/032003), aluminum, e.g., aluminum(III) biscitrate monocatecholate, manganese, cobalt, nickel, copper, or lead, e.g., a manganese oxide, a cobalt oxide, or a lead oxide. A benzoquinone may also be used as the redox active species. Other redox active species suitable for use in batteries of the invention are described in WO 2014/052682, WO 2015/048550, WO 2016/144909, and WO 2020/072406, the redox active species of which are incorporated by reference. The redox active species may be dissolved or suspended in solution (such as aqueous solution), be in the solid state, or be gaseous, e.g., molecular oxygen in air.

In some embodiments, the electrolytes are both aqueous, where the negolyte and posolyte, e.g., an anthraquinone and redox active species, are in aqueous solution or aqueous suspension. In addition, the electrolyte may include other solutes, e.g., acids (e.g., HCl) or bases (e.g., LiOH, NH₄OH, NaOH, or KOH) or alcohols (e.g., methyl, ethyl, or propyl) and other co-solvents to increase the solubility of a particular species, e.g., quinone/hydroquinone. Counter ions, such as cations, e.g., NH₄⁺, Li⁺, Na⁺, K⁺, or a mixture thereof, may also be present. In certain embodiments, the pH of the electrolyte may be >7, e.g., at least 8, 9, 10, 11, 12, 13, or 14, 8-14, 9-14, 10-14, 11-14, 12-14, 13-14, or about 14. The electrolyte may or may not be buffered to maintain a specified pH. The negolyte and posolyte will be present in amounts suitable to operate the battery, for example, from 0.1-15 M, or from 0.1-10 M. In some embodiments, the solution is at least 10%, 20%, 30%, 40%, 50%, 60%, 70%, or 80% water, by mass. Negolytes, e.g., quinones, hydroquinones, salts, and/or ions thereof may be present in a mixture.

The concentration of the organic species and redox active species may be any suitable amount. Ranges include, for example, from 0.1 M to liquid species, e.g., 0.1-15 M. In addition to water, solutions or suspensions may include alcohols (e.g., methyl, ethyl, or propyl) and other co-solvents to increase the solubility of a particular species. In some embodiments, the solution or suspension is at least 10%, 20%, 30%, 40%, 50%, 60%, 70%, or 80% water, by mass. Alcohol or other co-solvents may be present in an amount required to result in a particular concentration of species. The pH of the aqueous solution or suspension may also be adjusted by addition of acid or base, e.g., to aid in solubilizing a species.

Electrodes of the invention are disposed to provide an electrical pulse to the negolyte. The voltage requirements for the electrical pulse may depend upon the electrochemical properties of the organic species. In certain embodiments the first and third and/or third and fourth electrodes are disposed to provide the electrical pulse at a potential above the oxidation potential of the degradation product, e.g., at a potential at least +100 mV, +200 mV, +300 mV, +400 mV, +500 mV, +600 mV, +700 mV, +800 mV, +900 mV, or +1000 mV, +1100 mV, +1200 mV, +1300 mV, +1400 mV, or +1500 mV above the oxidation potential of the degradation product.

Electrodes suitable for use with negolytes of the invention include any carbon electrode, e.g., glassy carbon electrodes, carbon paper electrodes, carbon felt electrodes, or carbon nanotube electrodes. Other suitable electrodes may include metals such as stainless steel, copper, bismuth, or lead. Titanium electrodes may also be employed. Electrodes can also be made of a high specific surface area conducting material, such as a nanoporous metal sponge (T. Wada, A. D. Setyawan, K. Yubuta, and H. Kato, Scripta Materialia 65, 532 (2011)), which has been synthesized previously by electrochemical dealloying (J. D. Erlebacher, M. J. Aziz, A. Karma, N. Dmitrov, and K. Sieradzki, Nature 410, 450 (2001)), or a conducting metal oxide, which has been synthesized by wet chemical methods (B. T. Huskinson, J. S. Rugolo, S. K. Mondal, and M. J. Aziz, arXiv:1206.2883 [cond-mat.mtrl-sci]; Energy & Environmental Science 5, 8690 (2012); S. K. Mondal, J. S. Rugolo, and M. J. Aziz, Mater. Res. Soc. Symp. Proc. 1311, GG10.9 (2010)). Chemical vapor deposition can be used for conformal coatings of complex 3D electrode geometries by ultra-thin electrocatalyst or protective films. Electrodes suitable for other redox active species are known in the art.

The barrier allows the passage of ions, such as sodium or potassium, but not a significant amount of the negolyte or other redox active species. Examples of ion conducting barriers are NAFION®, i.e., sulfonated tetrafluoroethylene based fluoropolymer-copolymer, FUMASEP®, i.e., non-fluorinated, sulfonated polyaryletherketone-copolymer, e.g., FUMASEP® E-620(K), hydrocarbons, e.g., polyethylene, and size exclusion barriers, e.g., ultrafiltration or dialysis membranes with a molecular weight cut off of 100, 250, 500, or 1,000 Da. For size exclusion membranes, the required molecular weight cut off is determined based on the molecular weight of the negolytes and posolytes employed. Porous physical barriers may also be included, e.g., when the passage of redox active species is tolerable.

The battery may also include a controller that controls the charging of the negolyte. For example, the controller may charge the negolyte to less than 100%, e.g., less than 99, 98, 97, 96, 95, 90, 85, 80, 75, 70, 65, 60, 55, 50, or 45%. The controller may also provide a minimum state of charge, e.g., of at least 45%, such as at least 50, 55, 60, 65, 70, 75, 80, or 85%. For example, the state of charge may be maintained from 45-95%, such as 45-55%, 45-65%, 45-75%, 45-85%, 50-95%, 50-90%, 50-85%, 50-80%, 50-70%, 50-60%, 60-95%, 60-90%, 60-85%, 60-80%, 60-70%, 70-95%, 70-90%, 70-80%, 80-95%, 80-90%, 80-85%, 85-95%, 85-90%, or 90-95%. The controller may limit the state of charge by imposing a Coulomb constraint on the charging step.

The battery may also include a source of oxidizing agent in fluid communication with the negolyte and/or a gas dispersion element in the negolyte. Examples of oxidizing agents include molecular oxygen. In embodiments, the source of the oxidizing agent may be a container, e.g., fora liquid, solid, or gas, that is in fluid communication with the negolyte, i.e., connected to allow delivery of the agent to the negolyte. Containers include gas tanks, liquid reservoirs, and containers for solids. The negolyte may also include elements to disperse or mix the oxidizing agent including mixers, agitators, shakers, or gas dispersion elements (e.g., fritted glass elements). In embodiments, the oxidizing agent is molecular oxygen in ambient air, which can be delivered to the negolyte by a gas dispersion element. Gases, including ambient air, compressed air, or oxygen, may be filtered, dried, or otherwise processed prior to delivery to the negolyte. Batteries described herein may also include at least one electrocatalyst, e.g., graphene, carbon nanotubes, carbon nanoparticles, metal nanoparticles, or metal oxide nanoparticles in contact with the negolyte. In certain embodiments, the batteries described herein may include one or more redox mediators in contact with the negolyte, e.g., molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl-butanoic acid)), DBAQ (4,4′-(9,10-anthraquinone-diyl)dibutanoic acid), DPAQ (anthraquinone-2,6-dipropionic acid), a benzoquinone, ora naphthoquinone. The battery may include a source of hydronium or hydroxide ions, e.g., an acid or base, to, e.g., control the pH of the negolyte.

A battery of the invention may include additional components as is known in the art. Negolytes and posolytes may be housed in a suitable reservoir. A battery may further include one or more pumps to pump aqueous solutions or suspensions past one or both electrodes. Alternatively, the electrodes may be placed in a reservoir that is stirred or in which the solution or suspension is recirculated by any other method, e.g., convection, sonication, etc. Batteries may also include graphite flow plates and corrosion-resistant metal current collectors. Electrodes for applying the pulse (e.g., third and fourth electrodes) may be housed in an electrochemical cell, into which negolyte is pumped for regeneration. Alternatively, the electrochemical cell may be housed in a reservoir. An electrochemical cell may include the posolyte, or a second posolyte. The electrochemical cell may include a barrier, such as those described herein, to separate the negolyte and posolyte (or second posolyte).

The balance of the system around the cell includes fluid handling and storage, and voltage and round-trip energy efficiency measurements can be made. Systems configured for measurement of negolyte and posolyte flows and pH, pressure, temperature, current density and cell voltage may be included and used to evaluate cells. Fluid sample ports can be provided to permit sampling of both electrolytes, which will allow for the evaluation of parasitic losses due to reactant crossover or side reactions. Electrolytes can be sampled and analyzed with standard techniques.

Suitable cells, electrodes, membranes, and pumps for redox flow batteries are known in the art, e.g., WO 2014/052682, WO 2015/048550, WO 2016/144909, and WO 2020/072406, the battery components of which are hereby incorporated by reference.

### Methods

As described, the invention provides methods for reducing the loss of capacity in a flow battery, e.g., including a hydroquinone. In the methods, the negolyte is subjected to an electrical pulse after discharge to reduce the amount of a degradation product of an organic species in the negolyte.

Methods of the invention include regenerating the negolyte by, e.g., application of an electrical pulse to revert a degradation species formed from an organic species in the negolyte to oxidized organic species. For example, providing an electrical pulse of appropriate potential to the negolyte for a time sufficient to revert at least half of the degradation product to oxidized organic species. Reverting the degradation species and oxidation of the reduced organic species may be accompanied by concomitant reduction of the oxidized posolyte, thereby rebalancing the battery. The electrical pulse may be sufficient to revert, for example, at least 1% of the degradation species to oxidized organic species, e.g., from about 1% to 100% (e.g., about 1-10%, about 10-20%, about 20-30%, about 30-40%, about 40-50%, about 50-60%, about 60-70%, about 70-80%, about 80-90%, or about 90-100% or at least about 10%, at least about 25%, at least about 50%, at least about 75%, or at least about 95%).

The duration of the electrical pulse may depend on, e.g., the volume of negolyte. The electrical pulse may be applied for at least 10 min (e.g., about 10 to 20 min, 20 to 30 min, 30 to 40 min, 40 to 50 min, or 50 min to 60 min, or longer). The electrical pulse may be applied for between about 0.1 to about 48 hours (e.g., about 0.1 to 1 hours, 1 to 2 hours, 2 to 3 hours, 3 to 5 hours, 5 to 10 hours, 10 to 20 hours, 20 to 30 hours, 30 to 40 hours, or about 40 to 50 hours). The duration of the electrical pulse may be several days, e.g., between about 1 to 14 days (e.g., about 1 to 2 days, 2 to 5 days, 5 to 10 days, or 10 to 14 days). In some embodiments, the electrical pulse applied is, e.g., at a potential above the oxidation potential of the degradation product, e.g., at a potential at least +100 mV, +200 mV, +300 mV, +400 mV, +500 mV, +600 mV, +700 mV, +800 mV, +900 mV, +1000 mV, +1100 mV, +1200 mV, +1300 mV, +1400 mV, or +1500 mV above the oxidation potential of the degradation product.

The pulse can either be ‘potentiostatic’ (e.g., at constant potential), or ‘galvanostatic’ (e.g., at constant current), or mixture of both. The potential during the pulse may be variable. Where the potential during the pulse is variable, it may range between at least +100 mV to +1500 mV above the oxidation potential of the decomposition product) for at least about 1% of the pulse time, e.g., about 1% to 99% of the pulse time, (e.g., about 1-10%, 10-20%, 20-30%, 30-40%, 40-50%, 50-60%, 60-70%, 70-80%, 80-90%, or 10-100% of the pulse time).

In embodiments, the method involves pumping negolyte into an electrochemical cell including a third and fourth electrode and using the third and fourth electrode to regenerate the negolyte, e.g., by providing an electrical pulse as described herein.

Reducing the amount of the degradation produce may also include providing at least one electrocatalyst to the negolyte, e.g., graphene, carbon nanotubes, carbon nanoparticles, metal nanoparticles, or metal oxide nanoparticles. One or more redox mediators may also be provided to the negolyte, e.g., molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl- butanoic acid)), DBAQ (4,4′-(9,10-anthraquinone-diyl)dibutanoic acid), DPAQ (anthraquinone-2,6-dipropionic acid), a benzoquinone, or a naphthoquinone. The pH of the negolyte may also be altered, e.g., by adding or removing hydronium or hydroxide ions, e.g., by adding acid or base.

In embodiments of the methods described herein, the battery is cycled for at least 100 times.

The reduction of capacity loss may also include limiting the state of charge of the anthraquinone and/or by chemically oxidizing the negolyte after discharge. In controlling the state of charge, the method may limit the state of charge to 99, 98, 97, 96 or 95% or less, e.g., less than 90, 85, 80, 75, 70, 65, 60, 55, 50, or 45%. In embodiments, the state of charge is at least 60%, e.g., at least 65, 70, 75, 80, 85, or 90%. For example, the state of charge may be maintained between 45-95%, such as 45-55%, 45-65%, 45-75%, 45-85%, 50-95%, 50-90%, 50-85%, 50-80%, 50-70%, 50-60%, 60-95%, 60-90%, 60-85%, 60-80%, 60-70%, 70-95%, 70-90%, 70-80%, 80-95%, 80-90%, 80-85%, 85-95%, 85-90%, or 90-95%. Alternatively or in addition, the loss of capacity may be reduced by adding an oxidizing agent, e.g., molecular oxygen, to the negolyte after discharge. The oxidizing agent may be added after each discharge cycle or after a plurality of cycles, e.g., at least 10, 100, 500, or 1000. Gaseous oxidizing agents may be added passively or via a gas dispersion element that “bubble” gas into the negolyte. Passive addition relies on dissolution of ambient gas into the liquid, e.g., with stirring or shaking. Liquid and solid oxidizing agents may be added to the negolyte and mixed by stirring, shaking, or other agitation. The amount of oxidation agent can be determined by one of skill in the art to be sufficient to oxidize decomposition product in the negolyte, e.g., at 50% of the decomposition product, e.g., anthrone, produced, such as at least 60, 70, 80, 90, 95, or 99% of decomposition product present).

The methods of the invention may be employed to reduce loss of capacity as a function of time (independent of the number of cycles). In embodiments, the methods reduce the loss of capacity to a rate of less than 5% per day, e.g., less than 4, 3, 2, 1, 0.5, 0.1, 0.05, or 0.001. For example, the loss of capacity may be between 0.0001-5% per day, e.g., 0.0001-1%, 0.0001-0.1%, 0.0001-0.05%, 0.001-1%, 0.001-0.1%, 0.001-0.05%, 0.01-1%, 0.01-0.5%, or 0.01-0.1%. The methods may be practiced for a period of at least one week, one month, six months, or one year. The method may be applied to any organic or organometallic redox active species, such as an anthraquinone as described herein.

### EXAMPLES

The invention will be further described by the following non-limiting examples.

### Example 1

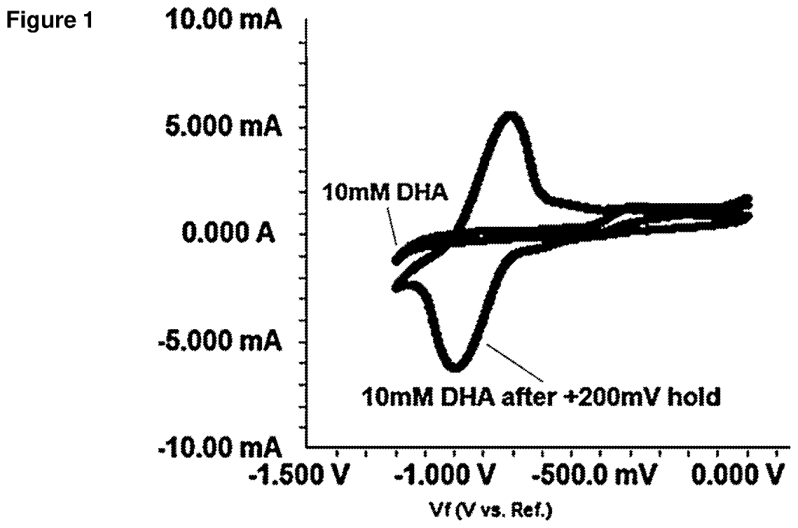

FIG. 1 shows cyclic voltammograms showing that after applying a +200 mV electrochemical pulse for 20 min, the DHA redox peak at −500 mV decreases, and a significant DHAQ redox peak around −900 mV is observed. All potentials vs. Ag/AgCl reference.

### Example 2

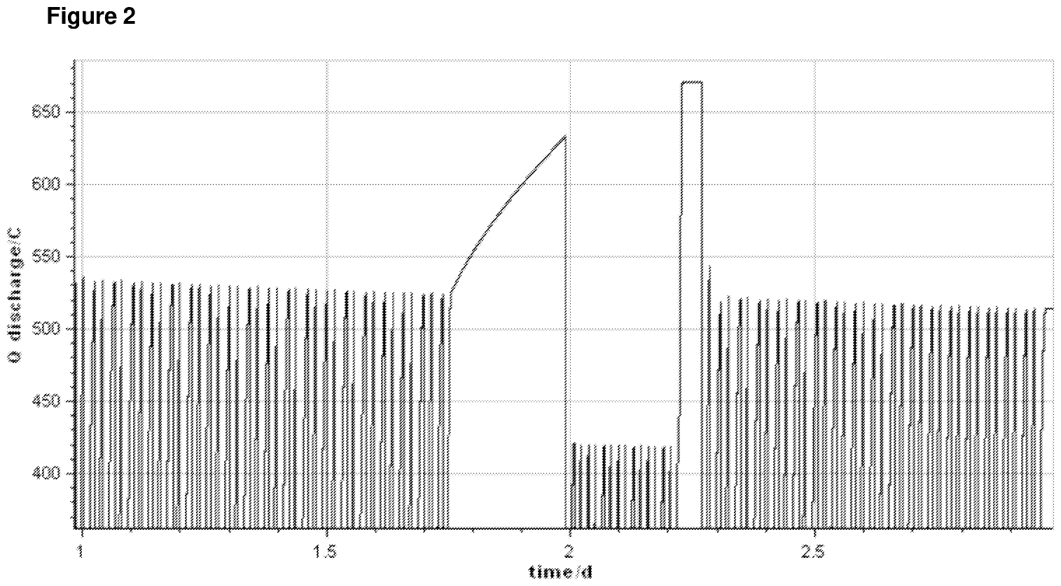

FIG. 2 shows full cell cycling of 0.5 M DHAQ vs. 0.4 M ferrocyanide cell, where DHAQ negolyte contains 50 mM of ferrocyanide to act as oxidative mediator. Capacity lost during charge hold (between 1.7-2.0 days) is mostly (˜90%) recovered after reverse polarization of cell at −0.5 V for 1 hour (at 2.2 days).

### Cell Cycling

All flow cell cycling tests were performed with a 5 cm² cell (Fuel Cell Tech, Albuquerque, NM) equipped with POCO sealed graphite flow plates with serpentine flow fields.

Flow of electrolytes was forced with a Cole-Parmer Masterflex L/S peristaltic pump, which required a small length of Viton peristaltic tubing. All other tubing and electrolyte reservoirs were made from chemically resistant fluorinated ethylene propylene (FEP).

Galvanostatic cycling of cell with potential holds at 1.5 V and 0.9 V and current cut-offs of 25 mA was performed in a glovebox with <2 ppm of oxygen with a Biologic VSP 300 potentiostat. All potentials in Example 2 are with respect to the cell potential.

### Example 3

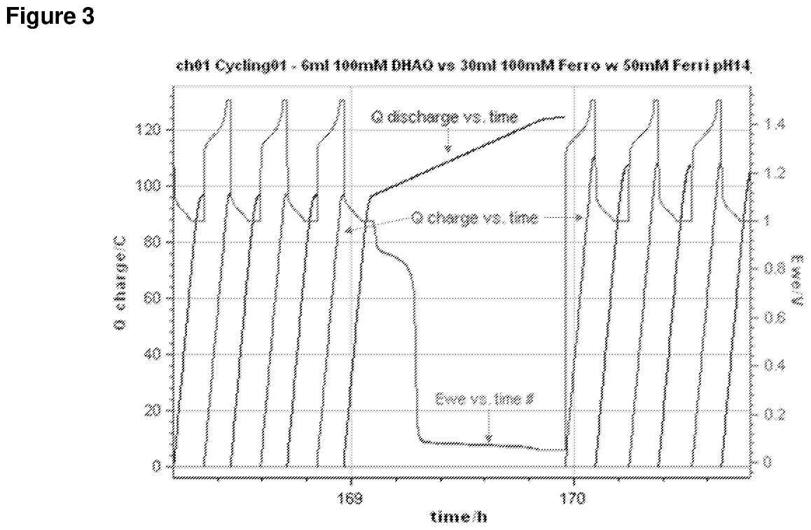

In FIGS. 3-5, cells were subjected to an electrical pulse after every 100 cycles. A negolyte solution of 6 ml 100 mM DHAQ and a 30 ml posolyte solution containing 100 mM potassium ferrocyanide with 50 mM potassium ferricyanide at pH 14 in an electrochemical cell assembled and operated according to the parameters and conditions listed in Table 1 was cycled 100 times before performing an electrical pulse step then resuming cycling to observe capacity recovery, and this process was repeated every 100 cycles. All potentials in Example 3 are with respect to the cell potential.

TABLE 1

| PARAMETER | CONDITION |
|---|---|
| Cell | ZJ cell |
| Location | Nitrogen Glovebox |
| Negolyte | 0.1M DHAQ @ pH 14 (6 ml = 115 C) |
| Posolyte | 0.1M K-ferrocyanide + 0.05M K-ferricyanide @ pH 14 |
| | (30 ml = 289 C) |
| Electrodes | 1× Zoltek PXFB (‘activated’) |
| Membrane | Nafion 117 (soaked in 1M KOH) |
| Gaskets | 1× 15 mil (380 μm) EPDM each side |
| Flow Plates | IDFF ZJ plates |
| Pumps | Peristaltic pumps @ 60 RPM |
| Cycling | 50 mA/cm² with holds @ 1.5 & 1.0 V, current cut-off = |
| | 1 mA/cm² |

FIG. 3 shows three cycles between 1 V and 1.5 V before and after an electrical pulse at 0.05 V for ˜40 min. The three cycles after reach a capacity of ˜108 C whereas the three charge-discharge cycles before had a capacity of about 98 C, e.g., holding the cell at 0.05 V led to a recovery ˜10 C of capacity after the electrical pulse.

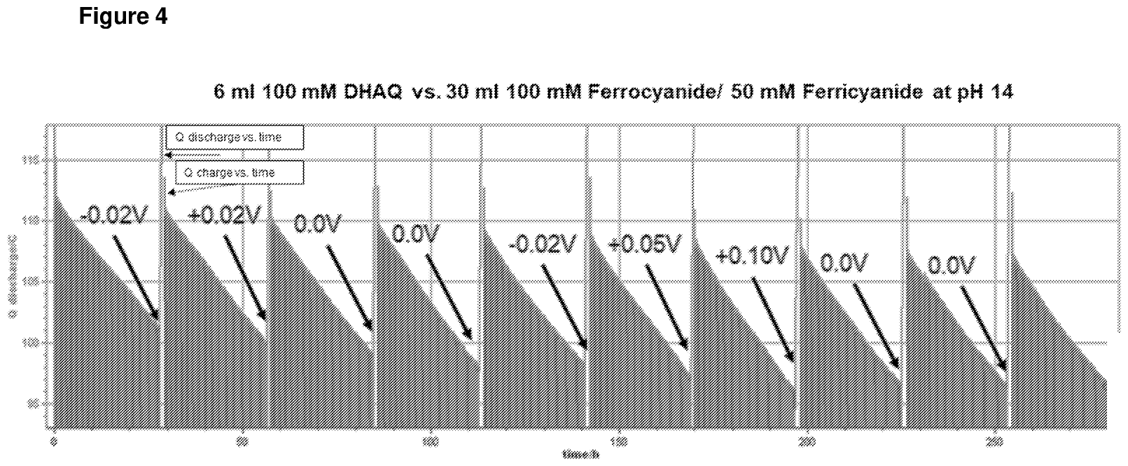

FIG. 4 shows full cell with electrical pulses at various pulse potentials interspersed every 100 cycles. FIG. 4 shows the Q charge and Q discharge vs. time over several segments of 100 cycles punctuated with electrical pulses at various potentials. The first electrical pulse was performed galvanostatically until the cell potential reached −0.02 V. Subsequent electrical pulses were performed identically until the cell potential reached: +0.02 V, 0.0 V, 0.0 V, −0.02 V, +0.05 V, +0.10 V, 0.0 V, and 0.0 V. In FIG. 4, the capacity recovers significantly after each electrical pulse before trending down again as the cell was cycled through the next set of 100 cycles.

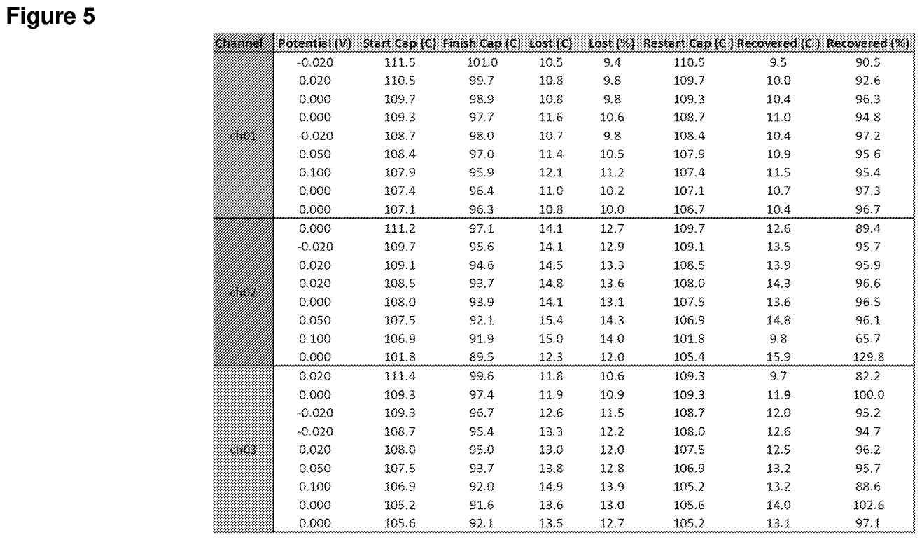

FIG. 5 is a table showing capacity recovery after an electrical pulse at various potentials in three cells (ch01, ch02, and ch03) cycled 100 times prior to each electrical pulse. Significant capacity recovery was observed in all three cells at all electrical pulse potentials tested.

Other embodiments are in the claims.

What is claimed is:

1. A method of discharging a flow battery comprising the steps of:
a) providing a flow battery comprising a negolyte comprising an organic species in aqueous solution or suspension in contact with a first electrode, a posolyte comprising a redox active species in contact with a second electrode, and a barrier separating the negolyte and posolyte, wherein the organic species degrades to a degradation product when the flow battery is discharged;
b) discharging the flow battery so that that the negolyte is oxidized and the posolyte is reduced; and
c) applying an electrical pulse to the negolyte sufficient to revert the degradation product to oxidized organic species.

2. The method of claim 1, wherein the organic species is a hydroquinone.

3. The method of claim 2, wherein the hydroquinone is a reduced form of an anthraquinone of formula (I): 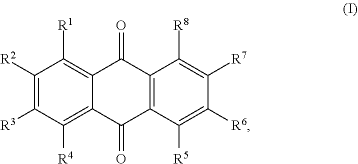
wherein each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —SRₐ; —N(Rₐ)₂; —C(═O)Rₐ; —C(═O)ORₐ; —S(═O)₂Rₐ; —S(═O)₂ORₐ; —P(═O)Rₐ₂; and —P(═O)(ORₐ)₂; or any two adjacent groups selected from R¹, R², R³, and R⁴ are joined to form an optionally substituted 3-6 membered ring, or an ion thereof, wherein each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

4. The method of claim 2, wherein the hydroquinone is a reduced form of 2,6-dihydroanthraquinone.

5. The method of claim 1, wherein the organic species is a hydronaphthoquinone, a reduced phenazine, a reduced N,N′-disubstituted phenazine, a reduced monoquaternized or N,N′-diquaternized phenazine, a reduced phenoxazine, a reduced phenothiazine, a reduced fluorenone, or a reduced diquaternized bipyridine.

6. The method of claim 1, wherein the electrical pulse is applied for between about 1 to about 48 hours.

7. The method of claim 1, wherein the electrical pulse applied is at a potential above the oxidation potential of the degradation product.

8. The method claim 1, wherein the electrical pulse is at a potential least +100 mV above the oxidation potential of the degradation product.

9. The method of claim 1, wherein step (c) further comprises providing at least one electrocatalyst to the negolyte.

10. The method of claim 9, wherein the electrocatalyst comprises graphene, carbon nanotubes, carbon nanoparticles, metal nanoparticles, or metal oxide nanoparticles.

11. The method of claim 1, wherein step (c) further comprises providing one or more redox mediators to the negolyte.

12. The method of claim 11, wherein the one or more redox mediators comprises molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl-butanoic acid)), DBAQ (4,4′-(9,10-anthraquinone-diyl)dibutanoic acid), DPAQ (anthraquinone-2,6-dipropionic acid), a benzoquinone, or a naphthoquinone.

13. The method of claim 1, wherein step (c) further comprises altering the pH of the negolyte.

14. The method of claim 1, wherein the electrode used to apply the electrical pulse comprises carbon or a metal.

15. A flow battery comprising:
i) a negolyte comprising an organic species in aqueous solution or suspension in contact with a first electrode;
ii) a posolyte comprising a redox active species in contact with a second electrode;
iii) a barrier separating the negolyte and posolyte; and
iv) a third electrode in contact with the negolyte;
wherein the third electrode is disposed to apply an electrical pulse to the negolyte.

16. The flow battery of claim 15, further comprising a fourth electrode in contact with the negolyte.

17. The flow battery of claim 15 or 16, wherein the third and/or fourth electrode is disposed within a reservoir or an electrochemical cell containing the negolyte.

18. The flow battery of claim 15, wherein the organic species is a hydroquinone.

19. The flow battery of claim 18, wherein the hydroquinone is a reduced form of an anthraquinone of formula (I): 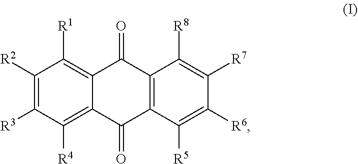
wherein each of R¹, R², R³, R⁴, R⁵, R⁶, R⁷ and R⁸ is independently selected from H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; —CN; —NO₂; —ORₐ; —SRₐ; —N(Rₐ)₂; —C(═O)Rₐ; —C(═O)ORₐ; —S(═O)₂Rₐ; —S(═O)₂ORₐ; —P(═O)Rₐ₂; and —P(═O)(ORₐ)₂; or any two adjacent groups selected from R¹, R², R³, and R⁴ are joined to form an optionally substituted 3-6 membered ring, or an ion thereof, wherein each Rₐ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

20. The flow battery of claim 18, wherein the hydroquinone is a reduced form of 2,6-dihydroanthraquinone.

21. The flow battery of claim 15, wherein the organic species is a hydronaphthoquinone, a reduced N,N′-disubstituted phenazine, a reduced monoquaternized or N,N′-diquaternized phenazine, a reduced phenoxazine, a reduced phenothiazine, a reduced phenazine, a reduced fluorenone, or a reduced diquaternized bipyridine.

22. The flow battery of claim 15 or 16, wherein the first and third and/or third and fourth electrodes are disposed to provide the electrical pulse at a potential above the oxidation potential of the degradation product.

23. The flow battery of claim 15, further comprising at least one electrocatalyst in contact with the negolyte.

24. The flow battery of claim 23, wherein the electrocatalyst comprises graphene, carbon nanotubes, carbon nanoparticles, metal nanoparticles, or metal oxide nanoparticles.

25. The flow battery of claim 15, further comprising one or more redox mediators in contact with the negolyte.

26. The flow battery of claim 25, wherein the one or more redox mediators comprises molecular oxygen, ferricyanide, potassium permanganate, DBEAQ (4,4′-([9,10-anthraquinone-2,6-diyl]dioxy)di-butyric acid), DPPEAQ ([9,10-dioxo-9,10-dihydroanthracene-2,6-diyl]bis[oxy]bis[propane-3,1-diyl])bis(phosphonic acid)), DPivOHAQ (3,3′-(9,10-anthraquinone-diyl)bis(3-methyl-butanoic acid)), DBAQ (4,4′-(9,10-anthraquinone-diyl)dibutanoic acid), DPAQ (anthraquinone-2,6-dipropionic acid), a benzoquinone, or a naphthoquinone.

27. The flow battery of claim 15, further comprising a source of hydronium and/or hydroxide ions.
